(19) United States
(12) Patent Application Publication
(10) Pub. No.: US 2015/0238988 A1
(43) Pub. Date: Aug. 27, 2015

(54) FITMENT FOR POLYMERIC BAG WITHIN FIBER SHELL CONTAINER

(71) Applicant: Mesurware, LLC, Kernersville, NC (US)

(72) Inventor: Keld Krogh Nielsen, Graasten (DK)

(21) Appl. No.: 14/626,411

(22) Filed: Feb. 19, 2015

Related U.S. Application Data
(60) Provisional application No. 61/942,905, filed on Feb. 21, 2014.

(51) Int. Cl. B05B 11/00; B65D 1/02

(52) U.S. Cl. CPC B05B 11/3004; B65D 1/0215; B65D 2501/0063; B65D 2501/009

(57) ABSTRACT

A fiber bottle includes: a fiber shell; a polymeric liner residing within the fiber shell; and a fitment attached to the polymeric liner. The fitment has a non-circular base and a hollow fitting to allow access to the interior of the polymeric liner, the fitment engaging one end of the fiber shell.

### RELATED APPLICATION

The present invention claims priority from and the benefit of U.S. Provisional Patent Application No. 61/942,905, filed Feb. 21, 2014, the disclosure of which is hereby incorporated herein in its entirety.

### FIELD OF THE INVENTION

The invention relates generally to containers, and more specifically to fiber shell containers with polymeric bag liners.

### BACKGROUND OF THE INVENTION

Traditionally, many beverages such as wine, beer and milk have been supplied in glass bottles. The glass used to make these bottles may itself be recycled. However, the energy required to make the bottles is high. Also, the weight of the resulting packaging is high, increasing the amount of energy required to transport the products. While the glass can be recycled, this does require that the bottles are separated from other waste, for example by users separating the glass bottles from other household waste for collection. Therefore, it is often the case that glass bottles are disposed of with other waste. In this case, the glass bottles may be disposed of in a landfill site. This is a problem since, unlike some other forms of waste, glass is not biodegradable.

More recently, it has become common to use bottles made from plastics, such as PET or HDPE, for liquid such as water, juice, carbonated drinks, or milk. In this case, it is common for the bottles to be formed from virgin, i.e., non-recycled, material to ensure that the liquid contained within the bottle is not contaminated as could be the case if the containers were formed from recycled material. While the material itself could be recycled if separated from other waste, as with glass bottles this frequently does not occur due to the need for the waste producer, such as a householder, to separate the containers from other waste material. Again, if the container is disposed of in a landfill site or the like, the bottle is not biodegradable. Also, bottles take up a volume larger than that of the material itself due to their hollow, rigid, structure, and therefore take up an excessive amount of space in a landfill site.

It has also been proposed to package liquid in laminated cardboard containers, for example in containers marketed by Tetra Pak. In this case, the cardboard from which the body of the container is formed may be virgin or recycled material. The cardboard is laminated with a waterproof coating. This ensures that the container is able to hold liquid and also acts as a barrier between the liquid and the cardboard, which can prevent contamination of the liquid from the cardboard. This is especially needed where the cardboard is formed from recycled material. A problem with such packages is that they are difficult to recycle, and the waterproof coating prevents them fully decomposing. The problem is exacerbated when a plastics dispensing nozzle or cap is formed as part of the package for dispensing the contents. This is another component that would need to be separated before the container can be recycled or parts of this be allowed to decompose.

In some countries, liquid such as milk is packaged in bags. However, these bags have little structural stability, and therefore are difficult to transport and to stack on shelves. They are often not re-sealable, making them hard to hold and carry.

It is known to package wine in boxes. These comprise a box body, typically formed of laminated cardboard, which provides the structure for the package. A bag is provided within the box, the wine being contained within the bag. A dispensing tap is often connected to the bag, and when in use is arranged to protrude through a side opening in the box. In such instances, the spout is made to protrude or hang outside of the box for dispensing. The weight of the liquid is usually distributed along the box bottom and is not supported by the dispensing tap protruding from the box. For the efficient disposal of such a container, each of the parts made from different materials would be also separated, namely the bag from the box, the dispensing tap from the bag, and the lamination from the cardboard forming the box. This separation of packaging components is difficult and prevents such packages from being disposed of or recycled efficiently.

Furthermore, in some cases bottles or other liquid containers contain additional, separable components that do not make it into a recycling bin. For example, loose caps, straws, and plastic tamperproof or tamper-evident devices can contribute to overall litter in the environment. Even if bottles make it into a recycling bin or garbage can, their caps or other types of closures often end up as general litter.

One solution is offered in U.S. Pat. No. 8,430,262 to Corbett et al., the disclosure of which is hereby incorporated herein by reference in its entirety. The proposed solution entails a bottle having a flexible polymeric bag within a fiber/pulp skeleton. The fiber skeleton is recyclable upon disposal. The bag (within which the liquid is held) is attached to a round polymeric “fitment” that snaps onto the top of the skeleton. A cap snaps onto the fitment to enable the bottle to be closed, then opened for dispensing.

### SUMMARY OF THE INVENTION

As a first aspect, embodiments of the invention are directed to a fiber bottle. The fiber bottle comprises: a fiber shell; a polymeric liner residing within the fiber shell; and a fitment attached to the polymeric liner. The fitment has a non-circular base and a hollow fitting to allow access to the interior of the polymeric liner, the fitment engaging one end of the fiber shell.

As a second aspect, embodiments of the invention are directed to a combination comprising a fiber bottle as described above and a liquid contained in the polymeric liner.

As a third aspects, embodiments of the invention are directed to the combination described above further comprising a dosing cap attached to the fitting of the fitment.

### BRIEF DESCRIPTION OF THE FIGURES

FIG. 1 is a perspective view of a fiber bottle according to embodiments of the present invention.

FIG. 2 is a perspective section view of the fiber bottle of FIG. 1.

FIG. 3 is a perspective view of the fitment for the bottle of FIG. 1.

FIG. 4 is a perspective section view of the fitment of FIG. 2.

FIG. 5 is a perspective section view of a cap attached to the fitment of FIG. 3, the cap shown in a closed position.

FIG. 6 is a perspective section view of the cap of FIG. 5, shown in an open position.

### DETAILED DESCRIPTION OF EMBODIMENTS OF THE INVENTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

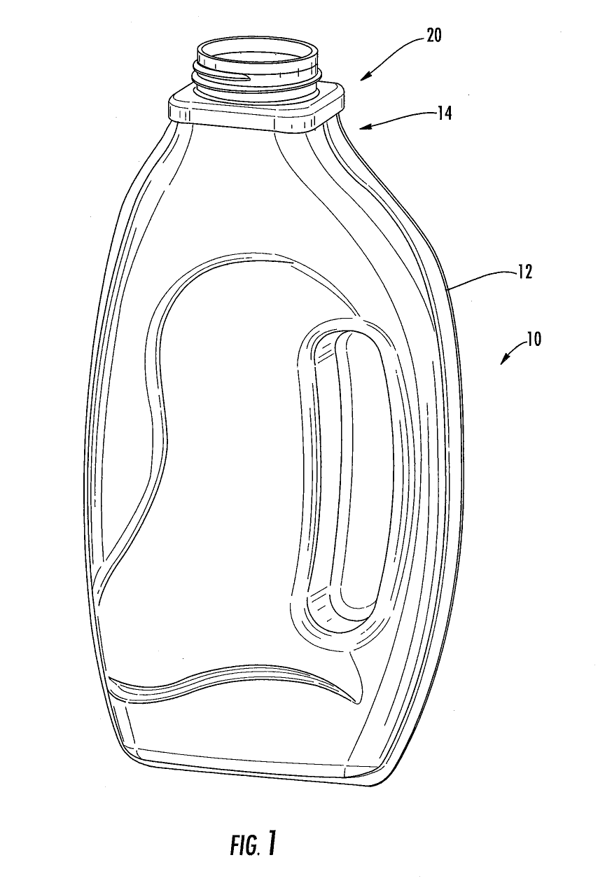

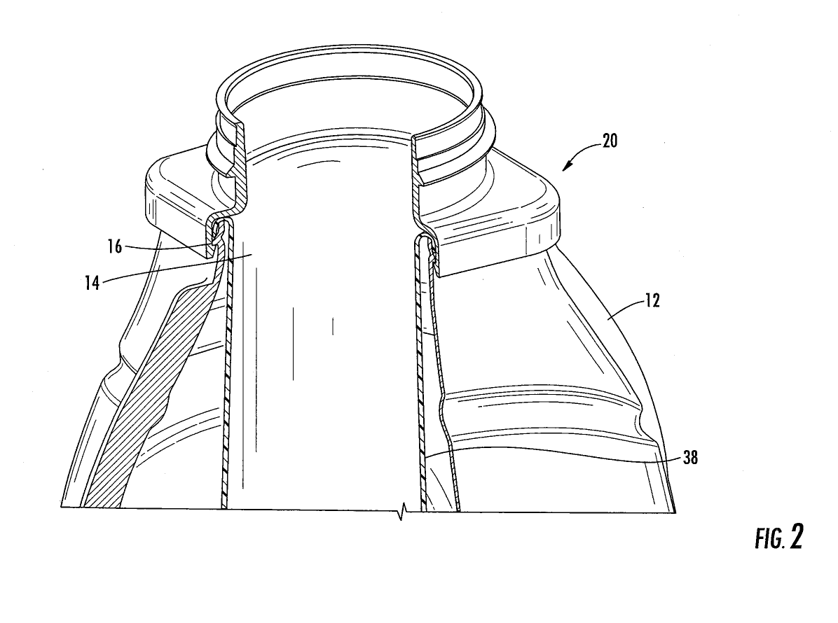

Referring now to the figures, a fiber bottle, designated broadly at 10, is shown in FIGS. 1 and 2. The fiber bottle 10 includes a fiber shell 12 of the type described above. At its upper end, the fiber shell 12 includes a generally square opening 14. A ridge 16 extends radially outwardly from a position just below the upper edge of the fiber shell 12. Those of skill in this art will appreciate that the fiber shell 12 may take any number of configurations, including cylindrical, spherical, oblong, and the like. An exemplary fiber shell (with appropriate modifications as discussed below) is illustrated and described in U.S. Pat. No. 8,430,262 to Corbett et al., supra. Exemplary materials include biodegradable materials, such as molded fiber, pulp or paper, which may in some embodiments comprise 100 percent post-consumer fiber or pulp feedstock.

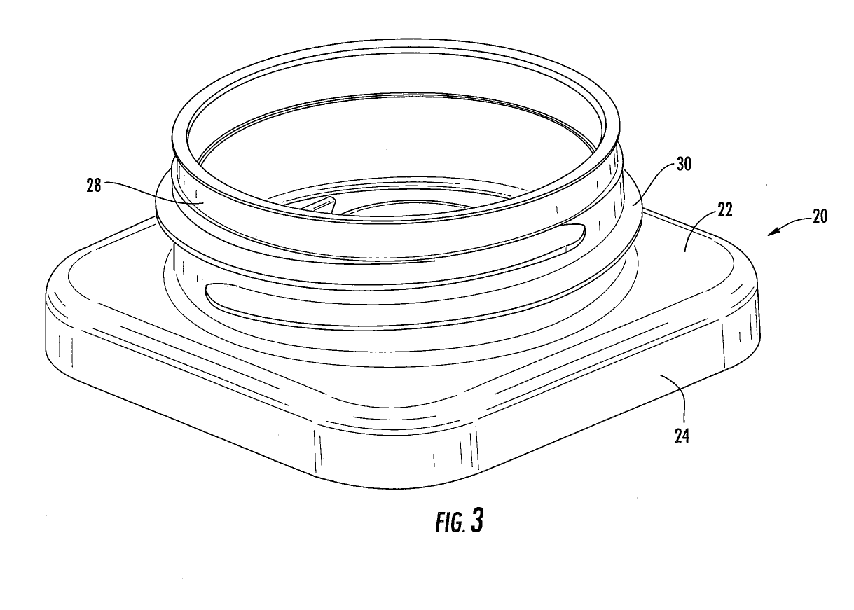

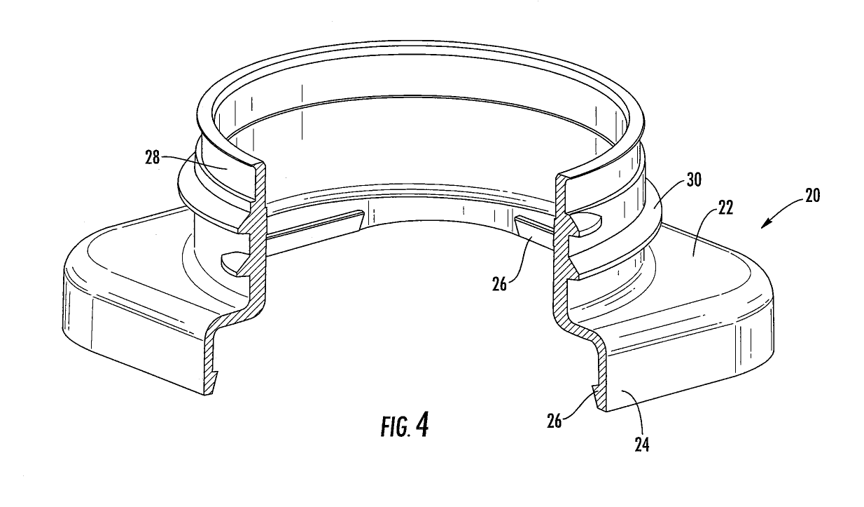

Referring now to FIGS. 3 and 4, an adaptive fitment 20 includes a generally square base 22. A downwardly-depending, generally square lip 24 extends away from the perimeter of the base 22. Four hooks 26 extend inwardly from the lower end of the lip 24, one from each side of the lip 24. As can be seen in FIG. 2, the fitment 20 is attached to the upper end of the fiber shell 12 and covers the opening 14. The hooks 26 extend below and engage the ridge 16 of the fiber shell 12, thereby maintaining the fitment 20 in position and preventing it from slipping off of the upper end of the fiber shell 12.

As discussed in the Corbett patent, supra, a polymeric liner 38 is attached to the fitment 20 and resides within the fiber shell 12 (see FIG. 2). The Corbett patent discusses multiple techniques for attaching the liner to the fitment 20, which need not be described in detail herein; these include bonding, sealing, welding and the like.

As can be seen in FIGS. 1-4, a cylindrical threaded fitting 28 rises from the center portion of the base 22. The fitting 28 includes threads 30 for mating with a complementary threaded cap. The fitting 28 is hollow, thereby allowing access to the interior of the liner attached to the fitment 20.

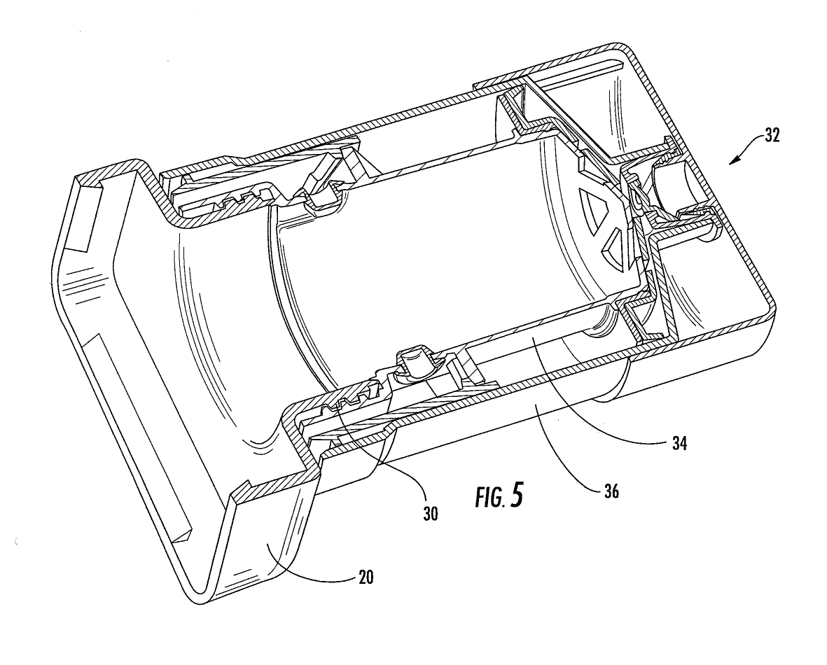

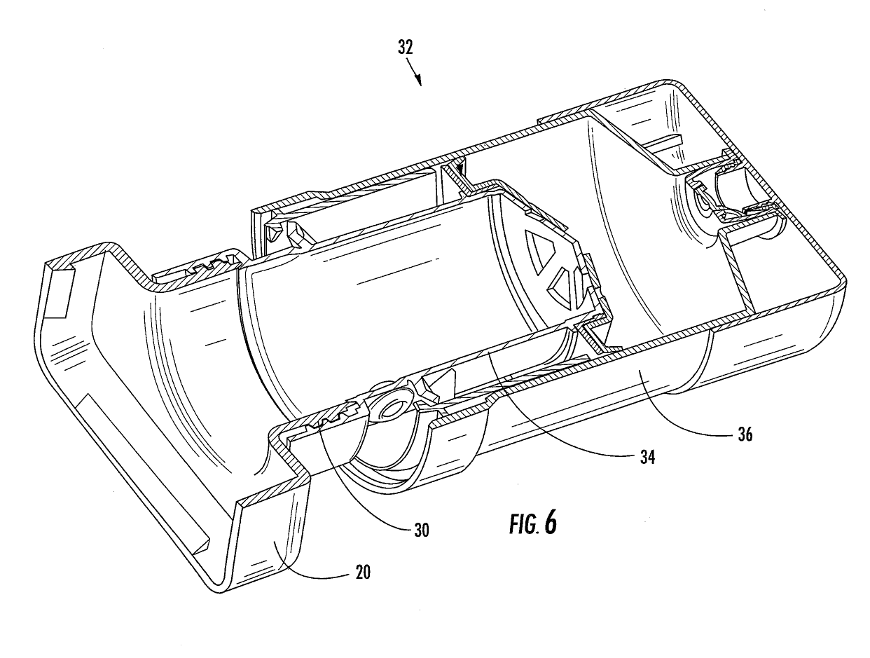

While any threaded cap may be fitted onto the threads 30, in some embodiments the cap may be of the dosing variety shown in FIGS. 5 and 6 and designated therein at 32. Such a dosing cap 32 is discussed in PCT Publication No. WO 2013/126553, the disclosure of which is hereby incorporated herein by reference. The cap shown therein comprises two telescoping pieces 34, 36 that rotate relative to each other (as shown in FIGS. 5 and 6) to effect dispensing, thereby providing the capability of providing a measured dose of liquid. Thus, the fiber bottle 10 with the cap 32 can provide an accurately dosing container that does not permit air to reach the liquid within the bag of the fiber bottle 10. The aseptic nature of such a dosing bottle may make the bottle particularly suitable for applications such as medications, laboratories, food products, and cosmetics.

Notably, the generally square shape of the base 22 of the fitment 20 maintains the orientation of the fitment 20 relative to the fiber shell 12, thereby preventing the fitment 20 from rotating relative to the fiber shell 12 along its long axis. Thus, the application, removal, replacement, etc. of the cap 32 on the threaded fitting 28 of the fitment 20 (which requires rotation of the cap 32 relative to the fitment 20) does not also rotate the fitment 20 relative to the fiber shell 12. As a result, the inner polymeric liner (not shown) attached to the fitment 20 would maintain its position within the fiber shell 12 rather than becoming twisted or tangled. Moreover, the fitment 20 does not tend to loosen upon rotation of the pieces 34, 36 of the cap 32, which may be the case if the fitment were screwed onto the neck of the fiber shell 12.

Those of skill in this art will appreciate that base 22 of the fitment may take different geometric configurations that would prevent relative rotation of the fitment 20 and the fiber shell 12. Exemplary alternative non-circular shapes include rectangular, triangular, pentagonal, hexagonal, octagonal, oblong, oval, and the like. In such an instance, the opening 14 of the fiber shell 12 would be reconfigured in a complementary shape. Shapes that have two axes of symmetry, such as squares, rectangles, and ovals, may be suitable for the base of the fitment due their ability to be oriented in multiple orientations relative to the fiber shell for proper attachment.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A fiber bottle, comprising:
a fiber shell;
a polymeric liner residing within the fiber shell; and
a fitment attached to the polymeric liner, the fitment having a non-circular base and a hollow fitting to allow access to the interior of the polymeric liner, the fitment engaging one end of the fiber shell.

2. The fiber bottle defined in claim 1, further comprising a dosing cap attached to the fitment.

3. The fiber bottle defined in claim 1, wherein the fitting is threaded.

4. The fiber bottle defined in claim 3, wherein the dosing cap is threaded to the fitting of the fitment, and wherein the dosing cap comprises two pieces that rotate relative to each other to dispense liquid.

5. The fiber bottle defined in claim 1, wherein the shape of the base is generally square, rectangular or oval.

6. The fiber bottle defined in claim 1, wherein the liner is attached to the base of the fitment.

7. The fiber bottle defined in claim 1, in combination with a liquid contained in the polymeric liner.

8. The combination defined in claim 7, wherein the fitting is threaded.

9. The combination defined in claim 7, wherein the shape of the base is generally square, rectangular or oval.

10. The combination defined in claim 7, wherein the liner is attached to the base of the fitment.

11. The combination defined in claim 7, further comprising a dosing cap attached to the fitment.

12. The combination defined in claim 11, wherein the dosing cap is threaded to the fitting of the fitment, and wherein the dosing cap comprises two pieces that rotate relative to each other to dispense liquid.

13. The fiber bottle defined in claim 11, wherein the shape of the base is generally square, rectangular or oval.

14. The fiber bottle defined in claim 11, wherein the liner is attached to the base of the fitment.
